(19) United States
(12) Patent Application Publication
(10) Pub. No.: US 2013/0247630 A1
(43) Pub. Date: Sep. 26, 2013

(54) COMPLEX OF DIVALENT METAL CATIONS AND CHELATING AGENT

(71) Applicants: Adrianus Maria Reichwein, Velp (NL); James N. Lepage, Chicago, IL (US); Teunis Scheperman, Twello (NL)

(72) Inventors: Adrianus Maria Reichwein, Velp (NL); James N. Lepage, Chicago, IL (US); Teunis Scheperman, Twello (NL)

(73) Assignee: AKZO NOBEL CHEMICALS INTERNATIONAL B.V., Amersfoort (NL)

(21) Appl. No.: 13/880,897

(22) PCT Filed: Oct. 28, 2011
(86) PCT No.: PCT/EP2011/068950

§ 371 Date: Apr. 22, 2013

Related U.S. Application Data
(60) Provisional application No. 61/407,623, filed on Oct. 28, 2010.

(30) Foreign Application Priority Data
Nov. 11, 2010 (EP) 10190775.6

(51) Int. Cl. C05F 11/00; C07F 3/06

(52) U.S. Cl. CPC C05F 11/00; C07F 3/06
USPC 71/27; 556/118

(57) ABSTRACT

The present invention relates to a complex of two divalent metal cations and a chelating agent chosen from the group of EDDHA (ethylenediamine-N,N′-di-(hydroxyphenyl acetic acid)), EDDHMA (ethylenediamine-N,N′-di-(hydroxy-methylphenyl acetic acid)), and HBED(N,N′-bis(hydroxybenzyl)ethylenediamine-N,N′-diacetic acid), a process to prepare such complex, plant nutrition compositions containing such complex and the use thereof as an algaecide, a bactericide, a herbicide, an insecticide, a molluscicide, a virucide or a fungicide, other than a fungicide or bactericide used for personal care.

The present invention relates to complexes of divalent metal cations and a chelating agent chosen from the group of EDDHA (ethylenediamine-N,N′-di-(hydroxyphenyl acetic acid)), EDDHMA (ethylenediamine-N,N′-di-(hydroxy-methylphenyl acetic acid)), and HBED (N,N′-bis(hydroxybenzyl)ethylenediamine-N,N′-diacetic acid), to the preparation thereof, and to the use thereof.

The chelating agents EDDHA, EDDHMA, and HBED have been known for some time and are often disclosed in connection with their use in plant nutrition compositions. For example, U.S. Pat. No. 2,921,847 and U.S. Pat. No. 4,130,582 disclose EDDHA; ACS Symposium series 910 Biogeochemistry of Chelating Agents (B. Nowack, J. M. vanBriesen, eds.), Chapter 21 “Theoretical modeling and reactivity of the iron chelates in agronomic conditions” by J. J. Lucena discloses EDDHA and EDDHMA; and R. L. Chaney, J. Plant Nutr. 11 (6-11), 1033-1050 (1988) discloses HBED and its use to make iron available in plant nutrition applications.

U.S. Pat. No. 6,139,879 discloses metal complexes of EDDHA and EDDHMA with a metal cation that is iron, copper, manganese, zinc, tin, and combinations thereof. The metal complexes contain one metal cation and one chelating agent and are said to be between 1 and 5% soluble.

Surprisingly, it has now been found to be possible to prepare complexes of EDDHA, EDDHMA or HBED with two divalent metal cations.

Accordingly, the present invention covers complexes of two divalent metal cations and a chelating agent chosen from the group of EDDHA, EDDHMA, and HBED.

These complexes containing two divalent metal cations have been found to have unexpected properties that can be of beneficial use in certain applications, like the ones which benefit from an unexpected low solubility over a broad pH range and/or a slow release of the divalent metal cation.

Preferably, the divalent metal cation is a metal cation that is not easily oxidized to a higher oxidation state. An example of a metal cation that can be easily oxidized to a higher oxidation state is iron, which is easily converted from the ferrous cation to the ferric cation. Accordingly, preferably, the metal cation is Mn²⁺, Cu²⁺, Zn²⁺, Ca²⁺ or Mg²⁺.

More preferably, the divalent metal cation is Mn²⁺, Cu²⁺ or Zn²⁺, most preferably it is Zn²⁺.

The chelating agents EDDHA, EDDHMA or HBED are intended to cover all their isomeric forms. Examples of chelating agents covered by the term EDDHA include o,o-EDDHA (ethylenediamine-N,N′-di(2-hydroxyphenyl acetic acid)), and o,p-EDDHA (ethylenediamine-N-(2-hydroxyphenyl acetic acid)-N′-(4-hydroxyphenyl acetic acid)), and examples of the chelating agent EDDHMA include o,o-EDDHMA (ethylenediamine-N,N′-di(2-hydroxy-4-methylphenyl acetic acid)) and o,o′-EDDHMA (ethylenediamine-N-(2-hydroxy-4-methylphenyl acetic acid)-N′-(2-hydroxy-6-methylphenyl acetic acid)).

In addition, the chelating agents EDDHA, EDDHMA or HBED in accordance with the present invention are intended to cover any derivatives thereof that are substituted with alkyl or alkoxy groups. Preferably, they are substituted with one or more C1-C8 alkyl or C1-C8 alkoxy groups on the phenyl group.

More preferably, the chelating agent is o,o-EDDHA, o,p-EDDHA, o,o-EDDHMA, or o,o′-EDDHMA.

Most preferably, the complex of the invention is Zn₂-o,o-EDDHA, Zn₂-o,o-EDDHMA or Zn₂-o,o′-EDDHMA.

The invention also relates to a process to prepare the complex of the invention, comprising the steps of adding the chelating agent and a soluble salt of the divalent cation to an aqueous solution at a neutral pH, allowing a precipitate to form, and, optionally, separating off the precipitate from the solution.

A neutral pH means a pH of between 5 and 9, preferably between 6 and 8, even more preferably between 6 and 7.

The chelating agent can be added to the aqueous solution in its acidic form or as a salt, such as its sodium and/or potassium (full or partial) salt.

The soluble salt of the divalent metal salt is preferably salt that is soluble in an amount of more than 1 g/100 ml, preferably more than 10 g/100 ml.

The step of separating off the precipitate from the solution in one embodiment takes the form of a filtration step. In another embodiment the precipitate can be separated off by a centrifuge step. The separating off step is optionally followed by washing of the precipitate. This washing step can be performed by resuspending the precipitate in water and again filtrating or centrifuging, but washing can also take place e.g. on the filter. Also, a subsequent drying step can be performed.

Suitable soluble salts of the divalent zinc cation are for example ZnSO₄, ZnCl₂, Zn(NO₃)₂, and zinc acetate. Suitable soluble salts of the divalent manganese cation are for example MnSO₄, MnCl₂, Mn(NO₃)₂, and manganese acetate, and suitable soluble salts of the divalent copper cation are CuSO₄, CuCl₂, Cu(NO₃)₂, and copper acetate.

The pH can be kept neutral during the process by the addition of NaOH, but other bases can be used as well, such as KOH, NH₄OH.

The temperature during the process is preferably 20 to 100° C., more preferably 60 to 80° C.

Moreover, the present invention relates to the use of the new complexes of the invention in plant nutrition compositions. In these uses the complexes of the present invention are of great benefit as they are hardly soluble, which makes them have a delayed (slow release) and long-term effect.

In addition, the invention provides plant nutrition compositions containing the complex of the invention and one or more of a suitable carrier, liquid, surfactant, a P source, a K source or a N source.

When the complex of the invention is added to a plant nutrition composition and subsequently the composition is applied to the plant or the soil to make it nutritionally available to the plant, due to the low solubility of the complex the nutrients will be available longer, as they will not be washed away by e.g. rain or sprinkling water.

The terms P source, N source or K source refer to components that are often added to plant nutrition compositions to deliver the appropriate amounts of phosphorus, nitrogen or potassium nutrients (also indicated as macronutrients) to the plant. They are collectively often referred to as NPK sources. Examples thereof for N sources are: urea, urea-formaldehyde, ammonia, ammonium salts or nitrate salts like ammonium sulfate, ammonium nitrate, calcium nitrate, potassium nitrate; for P sources: phosphates like phosphate rock and phosphate salts like mono- or dipotassium phosphate (i.e. KH₂PO₄ and K₂HPO₄), mono- or di-ammonium phosphate or polyphosphate: and for K sources: (potash) potassium salts like potassium chloride, potassium sulphate, and the aforementioned potassium nitrate and potassium phosphates. The most suitable liquid used in the plant nutrition composition is water.

Still further, the invention relates to the use of the new complexes as an algaecide, a bactericide, a herbicide, an insecticide, a molluscicide, a virucide or a fungicide, other than a fungicide or a bactericide used for personal care. The complexes of the present invention may be administered in formulations which may include the complexes as active or inert (adjuvant) ingredients.

Herein, “personal care” means products for and/or methods relating to treating hair (human, dog, and/or cat), including, bleaching, colouring, dyeing, conditioning, growing, removing, retarding growth, shampooing, styling; deodorants and antiperspirants; personal cleansing; colour cosmetics; products, and/or methods relating to treating skin (human, dog, and/or cat), including application of creams, lotions, and other topically applied products for consumer use; and products and/or methods relating to orally administered materials for enhancing the appearance of hair, skin, and/or nails (human, dog, and/or cat); and shaving.

### EXAMPLES

### Example 1

A one liter beaker is charged with 100.0 grams of water. Subsequently, 240.1 grams of a 29.68% (expressed as H4-EDDHA) solution of the sodium salt of EDDHA and 450.4 grams of a 14.04% solution of zinc sulfate are dosed simultaneously in one hour at room temperature. The pH of the reaction mixture is kept at 7.5 by dosing 26.4 grams of 50% NaOH. Precipitation of the product Zn2 EDDHA starts immediately.

After the dosing has finished, the reaction mixture is stirred for another 30 minutes and has a final pH of 7.6. The reaction mixture is evaporated to dryness at 40° C. and 46 mbar using a rotating evaporator, giving 198.1 grams of crude product. The crude product is suspended in an equal amount of water, stirred for one hour, and the solids are collected by vacuum filtration. Separation of the very fine suspension was done by filtration. The wet cake is resuspended in an equal amount of water, stirred for one hour, and separated by filtration to remove the sodium sulfate salt. The resulting wet cake is dried to constant weight at 45° C. under vacuum, giving 100 grams of the solid product Zn2-EDDHA.

### Example 2

A one liter beaker is charged with 100.0 grams of water. Subsequently, 275.5 grams of a 25.12% (expressed as H4-EDDHMA) solution of the sodium and potassium salt of EDDHMA and 404.9 grams of a 14.04% solution of zinc sulfate are dosed simultaneously in one hour at room temperature. The pH of the reaction mixture is kept at 7.5 by dosing 17.4 grams of 50% NaOH. Precipitation of the product Zn2 EDDHMA starts immediately.

After the dosing has finished, the reaction mixture is stirred for another 30 minutes and has a final pH of 7.6. The reaction mixture is evaporated to dryness at 40° C. and 46 mbar using a rotating evaporator, giving 205.7 grams of crude product. The crude product is suspended in an equal amount of water, stirred for one hour, and the solids are collected by vacuum filtration. Separation of the very fine suspension was done by filtration. The wet cake is resuspended in an equal amount of water, stirred for one hour, and separated by filtration to remove the sodium and potassium sulfate salts. The resulting wet cake is dried to constant weight at 45° C. under vacuum, giving 91 grams of the solid product Zn2-EDDHMA.

### Example 3

A one liter double walled reactor is charged with 151.0 grams of water and heated to 60° C. Subsequently, 500.2 grams of a 25.05% (expressed as H4-EDDHMA) solution of the sodium and potassium salt of EDDHMA and 364.7 grams of a 28.58% solution of zinc sulfate are dosed simultaneously in two hours at 60° C. The pH of the reaction mixture is kept at 6.5 by dosing 21.2 grams of 50% NaOH. Precipitation of the product Zn2 EDDHMA starts immediately.

After the dosing has finished, the reaction mixture is stirred for another 15 minutes and is cooled down to 33° C., resulting in a rise of the pH to 6.9. The precipitated product Zn2-EDDHMA is separated from the solution by centrifugation (Sieva, Bertold Hermle A. G.). Separation of the suspension that was prepared at elevated temperature was easier than in Examples 1 and 2 done at a lower temperature, because the particles are slightly bigger. The wet cake (50% solids content) is resuspended in an equal amount of water and the solid material is isolated again by centrifugation. This washing is repeated once more to remove the sodium and potassium sulfate salts. Finally, the wet cake is dried to constant weight at 45° C. under vacuum, giving 150 grams of the solid product Zn2-EDDHMA.

### Example 4

A one liter double-walled reactor is charged with 150.0 grams of water and heated to 80° C. Subsequently, 500.2 grams of a 25.05% (expressed as H4-EDDHMA) solution of the sodium and potassium salt of EDDHMA and 364.0 grams of a 28.58% solution of zinc sulfate are dosed simultaneously in two hours at 80° C. The pH of the reaction mixture is kept at 6.3 by dosing 15.7 grams of 50% NaOH. Precipitation of the product Zn2 EDDHMA starts immediately.

After the dosing has finished, the reaction mixture is stirred for another 30 minutes and is cooled down to 34° C., resulting in a rise of the pH to 6.9. The precipitated product Zn2-EDDHMA is separated from the solution by centrifugation (Sieva, Bertold Hermle A. G.). Again, separation of the suspension that was prepared at this elevated temperature is faster than in Examples 1 and 2 done at a lower temperature, because the particles are slightly bigger. The wet cake (58% solids content) is resuspended in an equal amount of water and the solid material is isolated again by centrifugation. This washing is repeated once more to remove the sodium and potassium sulfate salts. Finally, the wet cake is dried to constant weight at 45° C. under vacuum, giving 154 grams of the solid product Zn2-EDDHMA.

1. Complex of two divalent metal cations and a chelating agent chosen from the group of EDDHA (ethylenediamine-N,N′-di-(hydroxyphenyl acetic acid)), EDDHMA (ethylenediamine-N,N′-di-(hydroxy-methylphenyl acetic acid)), and HBED (N,N′-bis(hydroxybenzyl)ethylenediamine-N,N′-diacetic acid), and derivatives of EDDHA, EDDHMA and HBED that are substituted with alkyl or alkoxy groups, preferably substituted with one or more C1-C8 alkyl or alkoxy groups on the phenyl.

2. Complex of claim 1 wherein the chelating agent is selected from the group consisting of EDDHA (ethylenediamine-N,N′-di-(hydroxyphenyl acetic acid)), EDDHMA (ethylenediamine-N,N′-di-(hydroxy-methylphenyl acetic acid)), and HBED (N,N′-bis(hydroxybenzyl)ethylenediamine-N,N′-diacetic acid).

3. Complex of claim 1 wherein the divalent metal cation is Mn²⁺, Cu²⁺ or Zn²⁺.

4. Complex of claim 1 wherein the chelating agent is o,o-EDDHA, o,p-EDDHA, o,o-EDDHMA, or o,o′-EDDHMA.

5. Process to prepare the complex of claim 1 comprising the steps of adding the chelating agent and a soluble salt of the divalent metal cation to an aqueous solution at a neutral pH, allowing a precipitate to form, and, optionally, separating off the precipitate from the solution.

6. Process to use the complex of claim 1 in plant nutrition compositions comprising the step of applying the complex to a plant or soil.

7. Plant nutrition composition containing the complex of claim 1 and one or more of a carrier, liquid, surfactant, a P source, a K source or a N source.

8. An algaecide, a bactericide, a herbicide, an insecticide, a molluscicide, a virucide or a fungicide, other than a fungicide or bactericide used for personal care comprising the complex of claim 1.

9. Complex of claim 2 wherein the divalent metal cation is Mn²⁺, Cu²⁺ or Zn²⁺.

10. Complex of claim 2 wherein the chelating agent is o,o-EDDHA, o,p-EDDHA, o,o-EDDHMA, or o,o′-EDDHMA.

11. Process to prepare the complex of claim 2 comprising the steps of adding the chelating agent and a soluble salt of the divalent metal cation to an aqueous solution at a neutral pH, allowing a precipitate to form, and, optionally, separating off the precipitate from the solution.

12. Process to use the complex of claim 2 in plant nutrition compositions comprising the step of applying the complex to a plant or soil.

13. Plant nutrition composition containing the complex of claim 2 and one or more of a carrier, liquid, surfactant, a P source, a K source or a N source.

14. An algaecide, a bactericide, a herbicide, an insecticide, a molluscicide, a virucide or a fungicide, other than a fungicide or bactericide used for personal care comprising the complex of claim 2.

15. Process to prepare the complex of claim 4 comprising the steps of adding the chelating agent and a soluble salt of the divalent metal cation to an aqueous solution at a neutral pH, allowing a precipitate to form, and, optionally, separating off the precipitate from the solution.

16. Process to use the complex of claim 4 in plant nutrition compositions comprising the step of applying the complex to a plant or soil.

17. Plant nutrition composition containing the complex of claim 1 and one or more of a carrier, liquid, surfactant, a P source, a K source or a N source.

18. An algaecide, a bactericide, a herbicide, an insecticide, a molluscicide, a virucide or a fungicide, other than a fungicide or bactericide used for personal care comprising the complex of claim 4.
